(19) United States
(12) Patent Application Publication
(10) Pub. No.: US 2026/0230760 A1
(43) Pub. Date: Aug. 6, 2026

(54) EAR-WORN DEVICES PERFORMING NEURAL NETWORK-BASED PROCESSING OF SPEECH-LIKE AUDIO

(71) Applicant: Fortell Research Inc., New York, NY (US)

(72) Inventor: Nicholas Morris, Brooklyn, NY (US)

(21) Appl. No.: 19/464,725

(22) Filed: Jan. 30, 2026

Related U.S. Application Data
(60) Provisional application No. 63/752,033, filed on Jan. 31, 2025.

(51) Int. Cl. H04R 25/00

(52) U.S. Cl. CPC H04R 25/507; H04R 2225/43

(57) ABSTRACT

Speech enhancement circuitry in an ear-worn device may be configured to receive an audio stream and implement, using neural network circuitry, a neural network trained to generate a mask based, at least in part, on the audio stream. Based on applying the mask to the audio stream, the speech enhancement circuitry may be configured to generate an enhanced version of the audio stream in which a speech-like component of the audio stream is attenuated relative to a speech component of the audio stream. The speech enhancement circuitry may be configured to maintain the speech-like component of the audio stream and the speech component of the audio stream mixed together throughout a processing path of the speech enhancement circuitry.

### BACKGROUND

### Field

The present disclosure relates to ear-worn devices. Some aspects relate to performing neural network-based noise reduction on speech-like audio.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

Reducing noise in the output of ear-worn devices (e.g., hearing aids, cochlear implants, and earphones) is a difficult challenge. Recently, neural networks for separating speech audio from noise audio have been developed. Further description of such neural networks for reducing noise may be found in U.S. Patent No. 11,812,225, titled “Method, Apparatus and System for Neural Network Hearing Aid,” issued November 7, 2023, which is incorporated by reference herein in its entirety. The inventor has recognized that there may be a “gray area” between what is considered speech and what is considered noise. In other words, there may be different types of voice-based audio, including audio of actual speech (e.g., conversational speech) as well as speech-like audio. Speech-like audio may include, for example, musical voices, voices in musical theatre, rapping, singing in unison, electronic vocals, shouting, and/or crying. It may be desirable to treat such speech-like audio differently from audio of speech. For example, it may be desirable for the neural network-based noise reduction to generate an enhanced audio stream in which speech-like components are attenuated more than speech components, and noise components are attenuated more than speech-like components.

Conventional ear-worn devices may employ neural networks to separate an audio stream into multiple audio streams based on the source of the audio or the class of the audio, and then apply different processing to each of the multiple audio streams downstream of the neural network. The inventor has realized that it may be helpful for speech enhancement circuitry to maintain speech components and speech-like components in a single audio stream, rather than separating them into multiple audio streams. To realize this, a neural network may be trained to perform attenuation of speech-like components relative to speech components. More precisely, the neural network may be trained to generate a mask that, when applied to an audio stream, results in an enhanced version of the audio stream in which speech-like components are attenuated relative to speech components, without any separation of the audio stream into multiple streams.

The inventor has recognized that maintaining speech components and speech-like components in a single audio stream may be helpful for multiple reasons: 1. Forcing audio components into separate audio streams may distort coherence and naturalness. For example, audio components may interact in complex manners (e.g., through room reverberation). As another example, audio components may share frequency content. As a further example, blended or ambiguous sounds may not be easily separated 2. Recombining separated audio streams may lead to artifacts, for example, due to different processing applied to each stream and/or phase mismatches.

### BRIEF DESCRIPTION OF DRAWINGS

FIG. 1 illustrates an ear-worn device, in accordance with certain embodiments described herein;

FIG. 2 illustrates the speech enhancement circuitry of FIG. 1 in more detail, in accordance with certain embodiments described herein;

FIG. 3 illustrates a system for obtaining neural network training data, in accordance with certain embodiments described herein;

FIG. 4 illustrates a system for obtaining neural network training data, in accordance with certain embodiments described herein;

FIG. 5 illustrates a system for obtaining neural network training data, in accordance with certain embodiments described herein; and

FIG. 6 illustrates a hearing aid, in accordance with certain embodiments described herein.

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

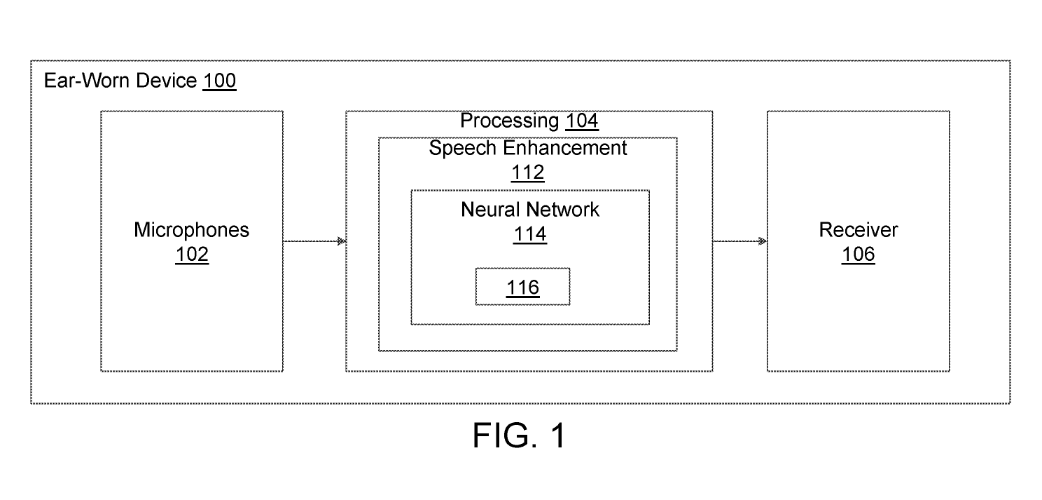

FIG. 1 illustrates an ear-worn device 100, in accordance with certain embodiments described herein. The ear-worn device 100 may be, for example, a hearing aid, a cochlear implant, or an earphone. The ear-worn device 100 includes microphones 102, processing circuitry 104, and a receiver 106. The processing circuitry 104 includes speech enhancement circuitry 112. The speech enhancement circuitry 112 includes neural network circuitry 114. The neural network circuitry 114 is configured to implement a neural network 116 (or, more generally, one or more neural network layers).

The one or more microphones 102 may include one, two, or more than two (e.g., 3, 4, or more) microphones. For example, the one or more microphones 102 may include two microphones, a front microphone that is closer to the front of the wearer of the ear-worn device 100 and a back microphone that is closer to the back of the wearer of the ear-worn device 100. As another example, the one or more microphones 102 may include more than two microphones in an array. Microphones in an array may be linked via wireless communication (e.g., the microphones may be disposed on two different ear-worn devices configured for binaural communication). The one or more microphones 102 may be configured to receive sound and to generate audio streams from the sound. The processing circuitry 104 may be configured to process the audio streams from the microphones 102. In particular, the processing circuitry 104 may be configured to use the speech enhancement circuitry 112 to perform noise reduction on the audio streams from the microphones 102, and the speech enhancement circuitry 112 may be configured to use the neural network circuitry 114 to perform the noise reduction. The processing circuitry 104 may additionally be configured to perform some or all of input calibration, anti-feedback processing, wind reduction, short-time Fourier transformation (STFT), wide dynamic range compression (WDRC), inverse STFT, and output calibration. The receiver 106 may be configured to play back the output of the processing circuitry 104 as sound into the ear of the user. The receiver 106 may also be configured to implement digital-to-analog conversion prior to the playing back.

Returning to the speech enhancement circuitry 112, in some embodiments the speech enhancement circuitry 112 may be configured to perform background noise reduction. In some embodiments, the speech enhancement circuitry 112 may be configured to perform background noise reduction and spatial focusing. The speech enhancement circuitry 112 may be configured to use the neural network 116 implemented by the neural network circuitry 114 to perform the background noise reduction, or the background noise reduction and the spatial focusing. In some embodiments, the neural network 116 may be trained to generate one or more outputs, such as a mask, configured to generate audio streams having reduced background noise, or reduced background noise in addition to spatial focus.

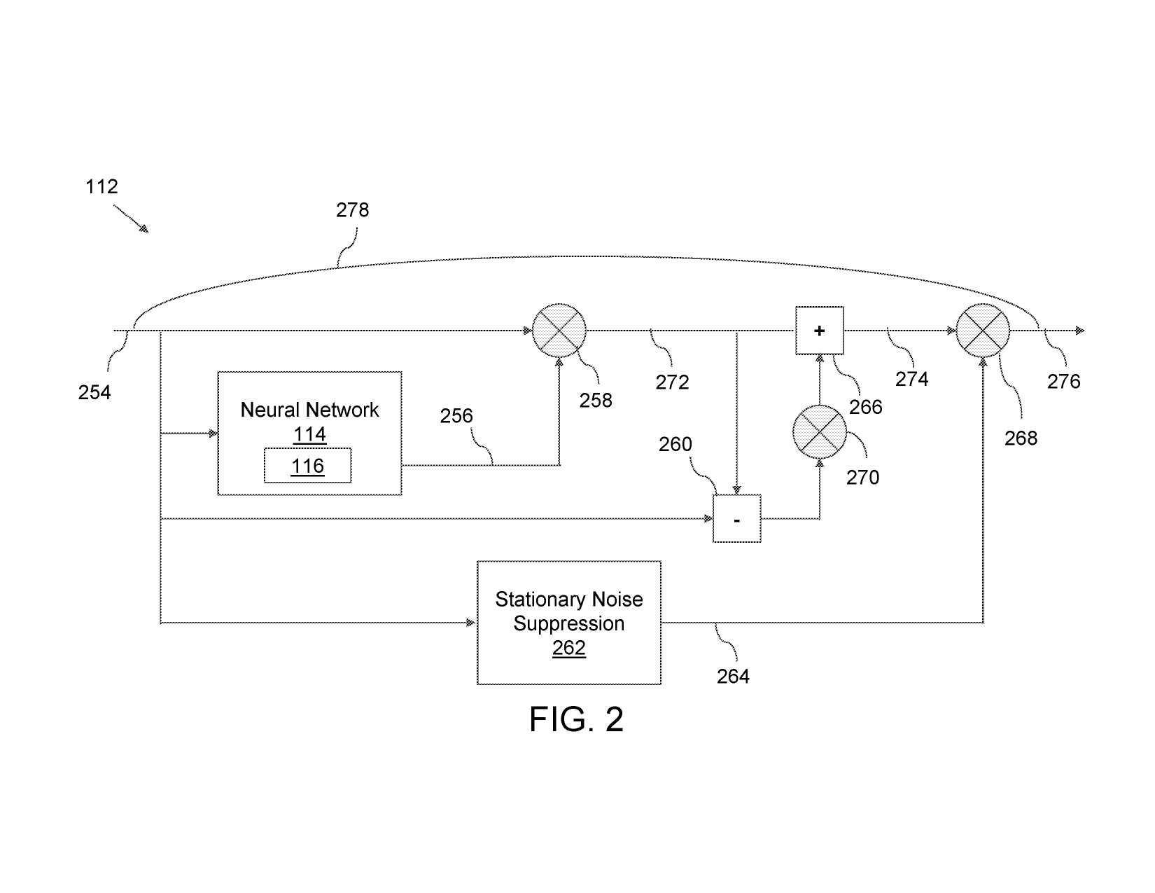

FIG. 2 illustrates the speech enhancement circuitry 112 in more detail, in accordance with certain embodiments described herein. The speech enhancement circuitry 112 includes the neural network circuitry 114, stationary noise suppression circuitry 262, multipliers 258, 268, and 270, adder 266, and subtractor 260.

Generally, the neural network circuitry 114 may be configured to receive an audio stream 254. The audio stream 254 may originate from sound received by microphones (e.g., the microphones 102, not illustrated in FIG. 2). For example, the audio stream 254 may be a processed version of an audio stream generated by the microphones. In some embodiments, the audio stream 254 may be a beamformed audio stream. The speech enhancement circuitry 112 may be further configured to implement, using the neural network circuitry 114, the neural network 116 to generate a mask based, at least in part, on the audio stream 254. In the example of FIG. 2, the multiplier 258 is configured to multiply the audio stream 254 by the mask 256, thereby resulting in an enhanced audio stream 272. However, the mask 256 may be applied to the audio stream 254 in other ways, such as addition. The mask 256 may be a real or complex mask that varies with frequency. Generally, when the mask 256 is applied to (e.g., multiplied by, or added to) the audio stream 254, the mask 256 may operate differently on different frequency components of the audio stream 254. In other words, applying the mask 256 to the audio stream 254 may cause different frequency components of the audio stream 254 to be modified by different real or complex values. A real mask may modify just magnitude, while a complex mask may modify both magnitude and phase.

As described above, the inventors have recognized that there is a “gray area” between what is considered speech and what is considered noise. In other words, there may be different types of voice-based audio, including audio of speech as well as speech-like audio. Speech-like audio may include, for example, musical voices, voices in musical theatre, rapping, singing in unison, electronic vocals, shouting, and/or crying. It may be desirable to treat such speech-like audio differently from audio of speech. Thus, the speech enhancement circuitry 112 may be configured, based on applying the mask 256 to the audio stream 254 (e.g., using the multiplier 258), to generate an enhanced audio stream 272 that is an enhanced version of the audio stream 254. In other words, applying the mask 256 may generate an enhanced version of the audio stream 254 having certain characteristics, further examples of which are provided below.

In some embodiments, in the enhanced audio stream 272, a speech-like component of the audio stream 254 may be attenuated relative to a speech component of the audio stream 254. Furthermore, a noise component of the audio stream 254 may be attenuated relative to the speech-like component of the audio stream 254. Thus, the speech-like component of the audio stream 254 may be attenuated to a greater degree than the speech component of the audio stream 254, and the noise component of the audio stream 254 may be attenuated to a greater degree than the speech-like component of the audio stream 254, when comparing the enhanced audio stream 272 with the audio stream 254. In some embodiments, the speech component of the audio stream 254 may be unattenuated when comparing the enhanced audio stream 272 with the audio stream 254. In some embodiments, the noise component of the audio stream 254 may be completely attenuated when comparing the enhanced audio stream 272 with the audio stream 254. In some embodiments, the noise component of the audio stream 254 may be excluded from the enhanced audio stream 272.

In some embodiments, in the enhanced audio stream 272, a speech component of the audio stream 254 may be weighted by a first value and a speech-like component of the audio stream 254 may be weighted by a second value. Furthermore, a noise component of the audio stream 254 may be weighted by a third value. The second value may be less than the first value, and the third value may be less than the second value. Thus, the speech-like component of the audio stream 254 may be weighted less than the speech component of the audio stream 254, and the noise component of the audio stream 254 may be weighted less than the speech-like component of the audio stream 254. In some embodiments, the second value (i.e., the value for the weight applied to the speech-like component) may be less than one and more than zero. In some embodiments, the first value (i.e., the value for the weight applied to the speech component) may be one. In some embodiments, the third value (i.e., the value for the weight applied to the noise component) may be zero. Thus, as a specific example, when comparing the enhanced audio stream 272 with the audio stream 254, noise components may be completely attenuated (e.g., weighted by 0), speech components may be completely unattenuated (e.g., weighted by 1), and speech-like components may be partially attenuated (e.g., weighted it by a value or values less than 1 but greater by 0).

In some embodiments, all speech-like components that are not actual speech may be weighted by the same value. In some embodiments, different types of speech-like components may be weighted by different values. For example, singing voices may be weighted by one value and shouting voices may be weighted by another value. Generally, based on applying the mask 256 to the audio stream 254, the speech enhancement circuitry 112 may be configured to produce the enhanced audio signal 272 in which a first speech-like component of the audio stream 254 is weighted by a first value and a second speech-like component is weighted by a second value different from the first value. From another perspective, based on applying the mask 256 to the audio stream 254, the speech enhancement circuitry 112 may be configured to produce the enhanced audio signal 272 in which a first speech-like component of the audio stream 254 is attenuated relative to a speech component by a first amount and a second speech-like component is attenuated relative to the speech component by a second amount different from the first amount.

The subtractor 260 may be configured to subtract the enhanced audio stream 272 from the audio stream 254, thus resulting in portions of the audio stream 254 not included in the enhanced audio stream 272 (e.g., noise components). The multiplier 270 may be configured to multiply these components by a weight which may be, for example, between 0 and 1. In some embodiments, this weight may vary as a function of some characteristic of the audio stream 254, such as stream-to-noise ratio (SNR). The result, which may be an attenuated version of components of the audio stream 254 not included in the enhanced audio stream 272, may then be added back to the enhanced audio stream 272 by the adder 266, resulting in an audio stream 274. Adding these components back to the enhanced audio stream 272 may help to increase environmental awareness for the wearer of the ear-worn device 100, and may also help reduce distortion that may result from use of a neural network.

The SNS circuitry 262 may be configured to receive the audio stream 254, generate an estimate of its stationary noise component, and generate a mask 264 configured to remove a certain amount of the stationary noise. In some embodiments, the SNS circuitry 262 may be configured to implement a minimum statistics noise estimation algorithm to generate the estimate of the stationary noise component of the audio stream 254. In some embodiments, the SNS circuitry 262 may be configured to implement other algorithms, in addition to or instead of the minimum statistics noise estimation algorithm, to generate the estimate of the stationary noise component of the audio stream 254 and/or to generate the mask 264. These algorithms may include, among non-limiting examples, spectral subtraction, Wiener filtering, and Ephraim-Malah techniques. Further description of such algorithms may be found in Chung, King. "Challenges and recent developments in hearing aids: Part I. Speech understanding in noise, microphone technologies and noise reduction algorithms." Trends in Amplification 8.3 (2004): 83-124, which is incorporated by reference herein in its entirety. The multiplier 268 may be configured to multiply the mask 264 by the audio stream 274, thereby removing a certain amount of stationary noise and resulting in an output audio stream 276.

It should be appreciated that throughout the processing path 278 of the speech enhancement circuitry 112, speech components and speech-like components are maintained in a single audio stream, rather than being separated into separate streams. In other words, the speech enhancement circuitry may be configured to maintain the speech-like components of the audio stream 254 and the speech components of the audio stream 254 mixed together throughout its processing path 278. Thus, the speech and speech-like components are mixed together in the audio stream 254 and remain mixed together in the enhanced audio stream 272, in the audio stream 274, and in the output audio stream 276. Applying the mask 256 does not separate speech components and speech-like components, but rather results in an enhanced audio stream 272 in which speech and speech-like components continue to be mixed together, but with different relative attenuations than in the audio stream 254. Thus, the speech enhancement circuitry 112 is not configured to separate speech components and speech-like components into separate audio streams. From another perspective, it should be appreciated that the neural network 116 does not perform classification of components of the audio stream 254 into speech components and speech-like components. The processing path 278 of the speech enhancement circuitry 112 may be considered to include the path of the audio stream 254 through all the circuitry in the speech enhancement circuitry 112 that converts it into the output audio stream 276.

The above description has described the neural network circuitry 114 receiving the audio stream 254. This should be understood to include the neural network circuitry 114 receiving only the audio stream 254, or receiving the audio stream 254 among other audio streams. In the latter scenario, the neural network 116 may generate the mask 256 based on the audio stream 254 and the other audio streams. However, the mask 256 might only be applied to one of the multiple audio streams (i.e., the audio stream 254). Generally, the neural network circuitry 114 may be configured to receive one or more audio streams (of which the audio stream 254 may be one). In some embodiments, the one or more audio streams may include one stream (i.e., the audio stream 254). In some embodiments, the one or more audio streams may include two streams. In some embodiments, the one or more audio streams may include three streams. In some embodiments, the one or more audio streams may include four streams. In some embodiments, the one or more audio streams may include more than four streams. In some embodiments, the one or more audio streams may be in the frequency domain. In some embodiments, the one or more audio streams may be in the time domain. In some embodiments, the neural network circuitry 114 may be configured to receive multiple audio streams together (i.e., not one after another). In some embodiments, the neural network circuitry 114 may be configured to process multiple audio streams together (i.e., not one after another).

In some embodiments, two or more of the audio streams may each have a different beamformed directional pattern. For example, one or more of the audio streams may be front-facing and one or more of the audio streams may be rear-facing. Front-facing beamformed audio streams may generally attenuate sound coming from behind the wearer more than sound coming from in front of the wearer, and back-facing beamformed audio streams may generally attenuate sound coming from in front of the wearer more than sound coming from behind the wearer. Example directional patterns include cardioids, supercardioids, hypercardioids, and dipoles. In some embodiments, the neural network circuitry 114 may instead be configured to receive non-beamformed audio streams, or a mix of beamformed and non-beamformed audio streams.

Prior to neural network processing, the neural network circuitry 114 may be configured to perform pre-processing on the audio stream 254. In some embodiments, the pre-processing may include short-time Fourier transformation. In some embodiments, the pre-processing may include feature extraction, which may include performing certain mathematical transformations such as taking the magnitude. In some embodiments, the pre-processing circuitry may include normalization.

In some embodiments, rather than the neural network circuitry 114 outputting a mask 256 configured to generate the enhanced audio stream 272, the neural network circuitry 114 may be configured to directly output the enhanced audio stream 272 itself. In such embodiments, the multiplier 258 may be absent. In some embodiments, components (e.g., noise components) might not be added back to the enhanced audio stream 272, or the components might already be present in the enhanced audio stream 272 at their proper attenuations. In such embodiments, the subtractor 260, multiplier 270, and adder 266 may be absent.

As described above, in some embodiments, the neural network 116 implemented by the neural network circuitry 114 may be trained to reduce noise. In some embodiments, the neural network 116 implemented by the neural network circuitry 114 may be trained to reduce noise and perform spatial focusing. With further regards to training, training the neural network 116 to perform noise reduction may include obtaining, as input training data, input audio streams containing noise and different types of voice-based audio components. Output audio streams that are versions of the input audio streams with the noise removed and the different types of voice-based audio components weighted by different weights may be determined. Then, masks that, when applied to the input audio streams, result in the output audio streams, may be determined and used as output training data. Based on the input training data and the output training data, the neural network 116 may learn how to output a mask 256 for the audio stream 254, such that when the mask 256 is applied to (e.g., multiplied by or added to) the audio stream 254, the resulting enhanced audio stream 272 has noise removed and different types of voice-based audio weighted by different weights.

In some embodiments, the neural network 116 may be trained to perform both noise reduction and spatial focusing. As described above, performing noise reduction may include generating a mask that, when applied to the audio stream 254, results in different types of audio components of the audio stream 254 (e.g., noise, speech, speech-like) weighted by different values. Spatial focusing in addition to noise reduction may include generating the mask such that, when the mask is applied to the audio stream 254, different types of audio components of the audio stream 254 (e.g., noise, speech, speech-like) are weighted by different values and each audio component of the audio stream 254 is further weighted by a value depending on its direction-of-arrival (DOA). For example, audio components of the audio stream 254 arriving from in front of the wearer may be weighted more than audio components of the audio stream 254 arriving from behind the wearer. However, the weighting of a speech-like component of the audio stream 254 by a value less than a value for weighting a speech component of the audio stream 254, as described above, may be independent of any weighting based on the DOA. In other words, consider that a speech-like component of the audio stream 254 is weighted by a weight x in the enhanced audio signal 272. At least a portion of this weight x may be independent of the DOA of the speech-like component. In still other words, a speech-like component of the audio stream 254 may be weighted by a different value than a value for weighting a speech component of the audio stream 254, even if the two components have the same DOA. In still other words, a speech-like component of the audio stream 254 may be weighted by a value less than a value for weighting a speech component of the audio stream 254 even if spatial focusing is turned off. From another perspective, the attenuation of a speech-like component of the audio stream 254 relative to a speech component of the audio stream 254, as described above, may be independent of any attenuation based on the DOA. In other words, consider that a speech-like component of the audio stream 254 is attenuated in the enhanced audio signal 272 by an amount x relative to a speech component. At least a portion of this attenuation amount x may be independent of the DOA of the speech-like component. In still other words, a speech-like component of the audio stream 254 may be attenuated relative to a speech component of the audio stream 254, even if the two components have the same DOA. In still other words, a speech-like component of the audio stream 254 may be attenuated relative to a speech component of the audio stream 254 even if spatial focusing is turned off. Neural network-based spatial focusing may require the neural network circuitry 114 to receive more than one audio stream 254, of which the audio stream 254 may be one. Further description of spatial focusing may be found in U.S. Patent No. 11,937,047, entitled “Ear-Worn Device with Neural Network for Noise Reduction and/or Spatial Focusing Using Multiple Input Audio Signals” issued March 19, 2024, which is incorporated by reference herein in its entirety.

This description may describe that the neural network 116 as trained to perform a certain action, or to generate an output for use in performing that action. As referred to herein, a neural network may be considered trained to perform a certain action if the neural network performs that action itself, or if it generates output for use in performing that action. Thus, it should be appreciated that the neural network 116 may be considered trained to perform noise reduction even if the neural network 116 itself does not generate a noise-reduced audio stream. If the neural network 116 generates a mask (or generally, an output) configured to generate a noise-reduced audio stream, the neural network 116 may still be considered trained to perform noise reduction. It should also be appreciated that the neural network 116 may be considered trained to perform noise reduction and spatial focusing even if the neural network itself does not generate a noise-reduced and spatially-focused audio stream. If the neural network 116 generates a mask (or generally, an output) configured to be used to generate a noise-reduced and spatially-focused audio stream, the neural network 116 may still be considered trained to perform noise reduction and spatial focusing. Additionally, the neural network may be considered a noise reduction neural network if it generates a noise-reduced stream or if it generates a noise-reducing mask (i.e., a mask that, when applied to an audio stream, results in a noise-reduced version of that audio stream).

Any neural network 116 described herein may be, for example, of the recurrent, vanilla/feedforward, convolutional, generative adversarial, attention (e.g. transformer), or graphical type. Generally, a neural network made up of such layers may include an input layer, a plurality of intermediate layers, and an output layer, and the layers may be made up of a plurality of neurons/nodes to which neural network weights may be applied.

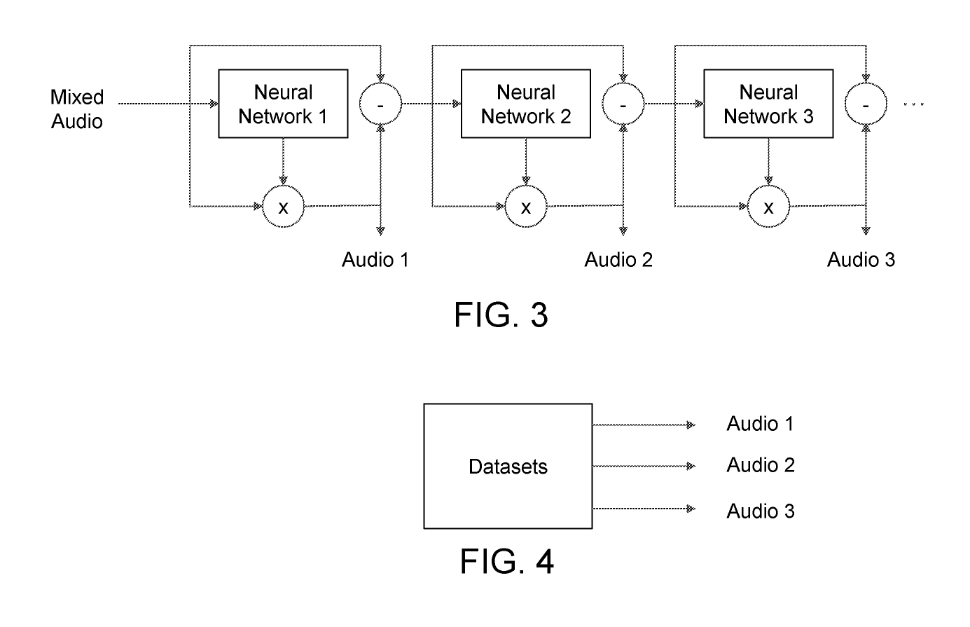

FIG. 3 illustrates a system for obtaining neural network training data, in accordance with certain embodiments described herein. As described above, training the neural network 116 may include obtaining, as input training data, input audio streams containing noise and different types of voice-based audio components. The system illustrated in FIG. 3 includes three neural networks for generating three types of audio data, but it should be appreciated that fewer or more neural networks may be used to generate fewer or more types of audio data. The first neural network may be trained to take a mixed audio stream (i.e., including different types of audio components mixed together) and separate out audio components of a first type (e.g., noise). In particular, the neural network may be configured to output a mask that, when applied to (e.g., multiplied by) the input audio stream, results in the audio components of the first type. Alternatively, in some embodiments, the neural network may directly output the audio components of the first type. The audio components of the first type may be subtracted from the mixed audio stream, resulting in components of the mixed audio stream aside from components of the first type, which may be input to a second neural network trained to separate out audio components of a second type (e.g., speech). The audio components of the second type may be subtracted from the audio stream input to the second neural network, resulting in components of the mixed audio stream aside from components of the first type and second type, which may be input to a third neural network trained to separate out audio components of a third type (e.g., speech-like components), and so on.

FIG. 4 illustrates a system for obtaining neural network training data, in accordance with certain embodiments described herein. In FIG. 4, the audio components of different types may be obtained from an already-prepared dataset, rather than separated out from a mixed audio stream using neural networks.

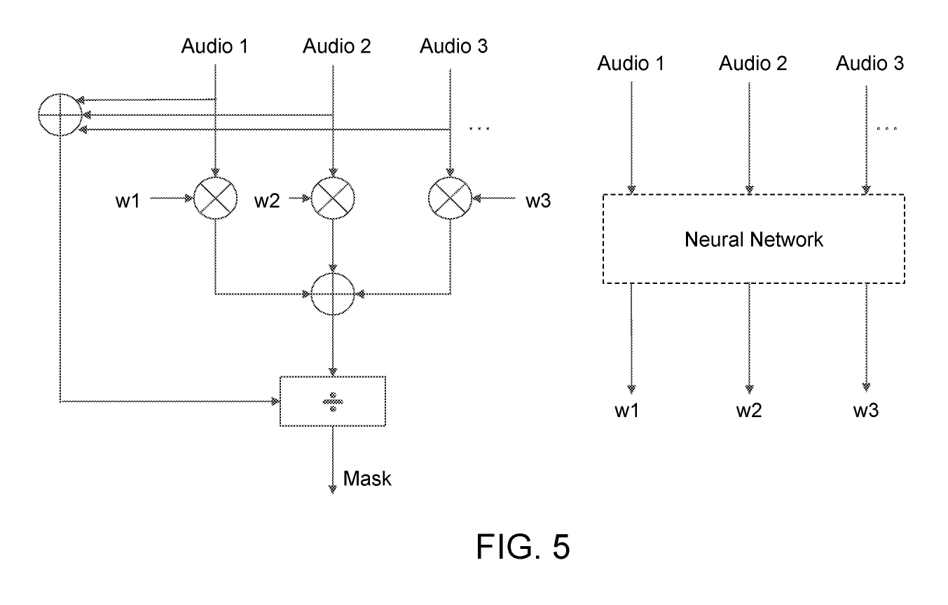

FIG. 5 illustrates a system for obtaining neural network training data, in accordance with certain embodiments described herein. While FIG. 5 illustrates audio components of three types, it should be appreciated that fewer or more types may be used. In FIG. 5, audio components of different types are multiplied by different weights and the results added together. For example, if the first type of audio is noise, the second type of audio is speech, and the third type of audio is speech-like, then the first weight may be 0, the second weight may be 1, and the third weight may be between 0 and 1. The sum of the weighted components (which may be equivalent to the original mixed audio stream of FIG. 3) may be divided by the sum of the unweighted components to produce a mask. The sum of the unweighted components, which may be equivalent to the original mixed audio stream, and the mask may be used as training data for training the neural network 116. FIG. 5 further illustrates that a neural network may optionally be trained to generate a weight for a given type of audio component. However, in some embodiments the weights may be determined without a neural network.

Deploying noise reduction techniques may introduce delays between when a sound is emitted by the sound source and when the noise-reduced sound is output to a user. For example, such techniques may introduce a delay between when a speaker speaks and when a listener hears the noise-reduced speech. During in-person communication, long latencies can create the perception of an echo as both the original sound and the noise-reduced version of the sound are played back to the listener. Additionally, long latencies can interfere with how the listener processes incoming sound due to the disconnect between visual cues (e.g., moving lips) and the arrival of the associated sound. To attain tolerable latencies when implementing a neural network on an ear-worn device, the ear-worn device may need to be capable of performing billions of operations per second. To address power issues with such demanding requirements, neural network circuitry (e.g., the neural network circuitry 114, and in some embodiments, other circuitry as well), may be implemented on a chip in the ear-worn device. Thus, in some embodiments, some or all of the processing circuitry 104 (including some or all of any of the speech enhancement circuitry 112 and/or some or all of any of the neural network circuitry 114) may be implemented on a single same chip (i.e., a single semiconductor die or substrate) in the ear-worn device. Further description of chips incorporating (in some embodiments, among other elements) neural network circuitry for use in ear-worn devices may be found in U.S. Patent No. 11,886,974, entitled “Neural Network Chip for Ear-Worn Device,” issued January 30, 2024, which is incorporated by reference herein in its entirety, as well as below.

The neutral network circuitry 114 may include circuitry configured to perform operations necessary for computing the output of a neural network layer. One such operation may be a matrix-vector multiplication. In some embodiments, neural network circuitry may include multiple identical tiles on the chip, each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein may be implemented as digital processing circuitry on the chip. In some embodiments, such digital processing circuitry may use a SIMD (single instruction multiple data) architecture. Thus, the chip may include the tiles and digital processing circuitry described above. In some embodiments, for a model having up to 10M 8-bit weights, and when operating at 100 GOPs/sec on time series data, the chip may achieve power efficiency of 4 GOPs/milliwatt, measured at 40 degrees Celsius, when the chip uses supply voltages between 0.5-1.8V, and when the chip is performing operations without idling. In some embodiments, in addition to such a chip, any of the ear-worn devices described herein may include a digital signal processor configured to perform other processing operations.

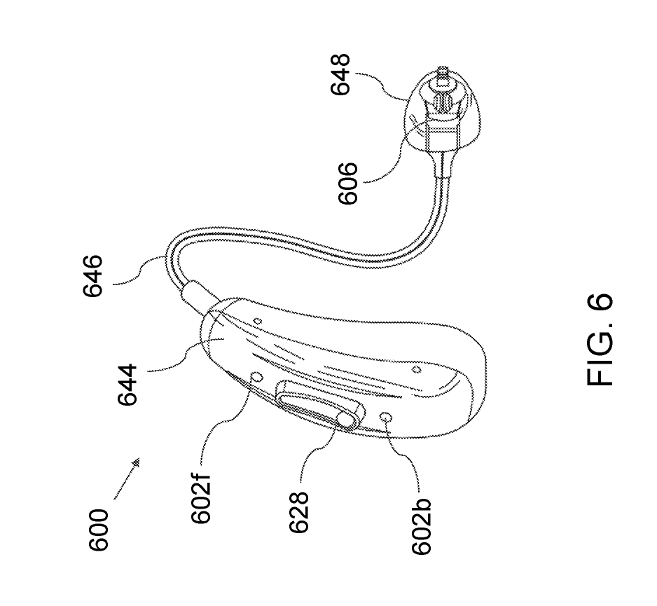

FIG. 6 illustrates a hearing aid 600, in accordance with certain embodiments described herein. The hearing aid 600 may be an example of any of the ear-worn devices or hearing aids described herein. The hearing aid 600 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 600 includes a body 644, a receiver wire 646, a receiver 606 (which may correspond to the receiver 106), and a dome 648. The body 644 is coupled to the receiver wire 646 and the receiver wire 646 is coupled to the receiver 606. The dome 648 is placed over the receiver 606. The body 644 includes a front microphone 602f, a back microphone 602b, and a user input device 628. (The front microphone 602f and the back microphone 602b may correspond to the one or more microphones 102) The body 644 additionally includes circuitry (e.g., any of the circuitry described above, aside from the receiver 606) not illustrated in FIG. 6. When the hearing aid 600 is worn, the front microphone 602f may be closer to the front of the wearer and the back microphone 602b may be closer to the back of the wearer. The front microphone 602f and the back microphone 602b may be configured to receive sound and generate audio streams based on the sound. Any of the microphones described herein may be the front microphone 602f and/or the back microphone 602b of the hearing aid 600. The user input device 628 (which may correspond to the user input device 128) may be configured to control certain functions of the hearing aid 600, such as switching modes.

The receiver wire 646 may be configured to transmit audio streams from the body 644 to the receiver 606. The receiver 606 may be configured to receive audio streams (i.e., those audio streams generated by the body 644 and transmitted by the receiver wire 646) and generate sound based on the audio streams. The dome 648 may be configured to fit tightly inside the wearer’s ear and direct the sound produced by the receiver 606 into the ear canal of the wearer.

In some embodiments, the length of the body 644 may be equal to 2 cm, equal to 5 cm, or between 2 and 5 cm in length. In some embodiments, the weight of the hearing aid 600 may be less than 4.5 grams. In some embodiments, the spacing between the microphones may be equal to 5 mm, equal to 12 mm, or between 5 and 12 mm. In some embodiments, the body 644 may include a battery (not visible in FIG. 6), such as a lithium ion rechargeable coin cell battery.

This disclosure includes, at least, the following examples:

Example A1 is directed to an ear-worn device comprising: speech enhancement circuitry comprising neural network circuitry and configured to: receive an audio stream; implement, using the neural network circuitry, a neural network trained to generate a mask based, at least in part, on the audio stream; and based on applying the mask to the audio stream, generate an enhanced version of the audio stream in which a speech-like component of the audio stream is attenuated relative to a speech component of the audio stream; wherein: the speech enhancement circuitry is configured to maintain the speech-like component of the audio stream and the speech component of the audio stream mixed together throughout a processing path of the speech enhancement circuitry.

Example A2 is directed to the ear-worn device of example A1, wherein the speech component of the audio stream is unattenuated.

Example A3 is directed to the ear-worn device of any of examples A1-A2, wherein, in the enhanced version of the audio stream generated based on applying the mask to the audio stream, a noise component of the audio stream is attenuated relative to the speech-like component of the audio stream.

Example A4 is directed to the ear-worn device of any of examples A1-A3, wherein the noise component of the audio stream is completely attenuated.

Example A5 is directed to the ear-worn device of any of examples A1-A4, wherein the noise component of the audio stream is excluded from the enhanced version of the audio stream.

Example A6 is directed to the ear-worn device of any of examples A1-A6, wherein: the speech-like component of the audio stream comprises a first speech-like component and is attenuated relative to the speech component of the audio stream by a first amount; and in the enhanced version of the audio stream, a second speech-like component of the audio stream is attenuated relative to the speech component of the audio stream by a second amount different from the first amount.

Example A7 is directed to the ear-worn device of any of examples A1-A6, wherein the speech-like component comprises musical vocals.

Example A8 is directed to the ear-worn device of any of examples A1-A6, wherein the speech-like component comprises shouting.

Example A9 is directed to the ear-worn device of any of examples A1-A6, wherein the speech-like component comprises crying.

Example A10 is directed to the ear-worn device of any of examples A1-A9, wherein the speech enhancement circuitry is not configured to separate the speech component of the audio stream and the speech-like component of the audio stream into separate audio streams.

Example A11 is directed to the ear-worn device of any of examples A1-A10, wherein the speech enhancement circuitry is configured to maintain the speech component of the audio stream and the speech-like component of the audio stream in a single audio stream.

Example A12 is directed to the ear-worn device of any of examples A1-A11, wherein the neural network is not configured to classify the speech component of the audio stream and the speech-like component of the audio stream.

Example A13 is directed to the ear-worn device of any of examples A1-A12, wherein applying the mask to the audio stream results in the speech component of the audio stream and the speech-like component of the audio stream continuing to be mixed together.

Example A14 is directed to the ear-worn device of any of examples A1-A13, wherein the neural network comprises a noise reduction neural network.

Example A15 is directed to the ear-worn device of any of examples A1-A14 wherein the mask comprises a noise-reducing mask.

Example A16 is directed to the ear-worn device of any of examples A1-A15, wherein the neural network is trained to perform noise reduction.

Example A17 is directed to the ear-worn device of any of examples A1-A16, wherein at least a portion of an attenuation of the speech-like component of the audio stream relative to the speech component of the audio stream is independent of a direction-of-arrival of the speech-like component.

Example B1 is directed to an ear-worn device comprising: speech enhancement circuitry comprising neural network circuitry and configured to: receive an audio stream; implement, using the neural network circuitry, a neural network trained to generate a mask based, at least in part, on the audio stream; and based on applying the mask to the audio stream, generate an enhanced version of the audio stream in which a speech component of the audio stream is weighted by a first value, a speech-like component of the audio stream is weighted by a second value, and the second value is less than the first value; wherein: the speech enhancement circuitry is configured to maintain the speech-like component of the audio stream and the speech component of the audio stream mixed together throughout a processing path of the speech enhancement circuitry.

Example B2 is directed to the ear-worn device of example B1, wherein, in the enhanced version of the audio stream generated based on applying the mask to the audio stream, a noise component of the audio stream is weighted by a third value, and the third value is less than the second value.

Example B3 is directed to the ear-worn device of any of examples B1-B2, wherein the second value is less than one and more than zero.

Example B4 is directed to the ear-worn device of any of examples B1-B3, wherein the first value is one.

Example B5 is directed to the ear-worn device of any of examples B1-B4, wherein the third value is zero.

Example B6 is directed to the ear-worn device of any of examples B1-B6, wherein: the speech-like component of the audio stream comprises a first speech-like component; and in the enhanced version of the audio stream, a second speech-like component of the audio stream is weighted by a fourth value different from the second value.

Example B7 is directed to the ear-worn device of any of examples B1-B6, wherein the speech-like component comprises musical vocals.

Example B8 is directed to the ear-worn device of any of examples B1-B6, wherein the speech-like component comprises shouting.

Example B9 is directed to the ear-worn device of any of examples B1-B6, wherein the speech-like component comprises crying.

Example B10 is directed to the ear-worn device of any of examples B1-B9, wherein the speech enhancement circuitry is not configured to separate the speech component of the audio stream and the speech-like component of the audio stream into separate audio streams.

Example B11 is directed to the ear-worn device of any of examples B1-B10, wherein the speech enhancement circuitry is configured to maintain the speech component of the audio stream and the speech-like component of the audio stream in a single audio stream.

Example B12 is directed to the ear-worn device of any of examples B1-B11, wherein the neural network is not configured to classify the speech component of the audio stream and the speech-like component of the audio stream.

Example B13 is directed to the ear-worn device of any of examples B1-B12, wherein applying the mask to the audio stream results in the speech component of the audio stream and the speech-like component of the audio stream continuing to be mixed together.

Example B14 is directed to the ear-worn device of any of examples B1-B13, wherein the neural network comprises a noise reduction neural network.

Example B15 is directed to the ear-worn device of any of examples B1-B14 wherein the mask comprises a noise-reducing mask.

Example B16 is directed to the ear-worn device of any of examples B1-B15, wherein the neural network is trained to perform noise reduction.

Example B17 is directed to the ear-worn device of any of examples B1-B16, wherein at least a portion of the second weight is independent of a direction-of-arrival of the speech-like component.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device comprising:
speech enhancement circuitry comprising neural network circuitry and configured to:
receive an audio stream;
implement, using the neural network circuitry, a neural network trained to generate a mask based, at least in part, on the audio stream; and
based on applying the mask to the audio stream, generate an enhanced version of the audio stream in which a speech-like component of the audio stream is attenuated relative to a speech component of the audio stream; wherein:
the speech enhancement circuitry is configured to maintain the speech-like component of the audio stream and the speech component of the audio stream mixed together throughout a processing path of the speech enhancement circuitry.

2. The ear-worn device of claim 1, wherein the speech component of the audio stream is unattenuated.

3. The ear-worn device of claim 1, wherein, in the enhanced version of the audio stream generated based on applying the mask to the audio stream, a noise component of the audio stream is attenuated relative to the speech-like component of the audio stream.

4. The ear-worn device of claim 1, wherein the noise component of the audio stream is completely attenuated.

5. The ear-worn device of claim 1, wherein the noise component of the audio stream is excluded from the enhanced version of the audio stream.

6. The ear-worn device of claim 1, wherein:
the speech-like component of the audio stream comprises a first speech-like component and is attenuated relative to the speech component of the audio stream by a first amount; and
in the enhanced version of the audio stream, a second speech-like component of the audio stream is attenuated relative to the speech component of the audio stream by a second amount different from the first amount.

7. The ear-worn device of claim 1, wherein the speech-like component comprises musical vocals.

8. The ear-worn device of claim 1, wherein the speech-like component comprises shouting.

9. The ear-worn device of claim 1, wherein the speech-like component comprises crying.

10. The ear-worn device of claim 1, wherein the speech enhancement circuitry is not configured to separate the speech component of the audio stream and the speech-like component of the audio stream into separate audio streams.

11. The ear-worn device of claim 1, wherein the speech enhancement circuitry is configured to maintain the speech component of the audio stream and the speech-like component of the audio stream in a single audio stream.

12. The ear-worn device of claim 1, wherein the neural network is not configured to classify the speech component of the audio stream and the speech-like component of the audio stream.

13. The ear-worn device of claim 1, wherein applying the mask to the audio stream results in the speech component of the audio stream and the speech-like component of the audio stream continuing to be mixed together.

14. The ear-worn device of claim 1, wherein the neural network comprises a noise reduction neural network.

15. The ear-worn device of claim 1, wherein the mask comprises a noise-reducing mask.

16. The ear-worn device of claim 1, wherein the neural network is trained to perform noise reduction.

17. The ear-worn device of claim 1, wherein at least a portion of an attenuation of the speech-like component of the audio stream relative to the speech component of the audio stream is independent of a direction-of-arrival of the speech-like component.
